(19) United States
(12) Patent Application Publication
(10) Pub. No.: US 2006/0073798 A1
(43) Pub. Date: Apr. 6, 2006

(54) Tuner

(76) Inventors: David Sawyer, Swindon (GB); Nicholas Paul Cowley, Wroughton (GB)

Correspondence Address: ARENT FOX PLLC, 1050 CONNECTICUT AVENUE, N.W., SUITE 400, WASHINGTON, DC, 20036, US

(21) Appl. No.: 11/193,382

(22) Filed: Aug. 1, 2005

(30) Foreign Application Priority Data
Aug. 6, 2004 (GB) 0417539.4

(51) Int. Cl. H04B 1/18

(52) U.S. Cl. 455/150.1

(57) ABSTRACT

A single conversion tuner comprises an image reject downconverter and a plurality of tracking RF bandpass filters ahead of the downconverter for providing image rejection. The downconverter comprises first and second mixers which mix the signal from the filters with quadrature commutating signals from a commutating signal generator. The mixer outputs are filtered by first and second roofing filters and the filtered signals are summed in a summer amplifier. The roofing filters may be off-chip inductance/capacitance filters.

### TECHNICAL FIELD

The present invention relates to a tuner. Such a tuner, is particularly suitable for use in US digital terrestrial (ATSC) applications but is also suitable for other distribution media and modulation schemes.

### BACKGROUND

ATSC (Advanced Television Standards Committee) is a digital terrestrial standard being deployed in USA and is being investigated for other markets worldwide. This scheme uses a multi-level VSB (vestigial sideband) modulated carrier and is designed to operate alongside existing analogue transmissions without causing noticeable degradations in the quality of reception of the existing analogue services.

To achieve this, the ATSC carriers are transmitted at a significantly lower power than the neighbouring analogue channels. There exist recommended practices, which define the relative levels of ATSC to analogue and other ATSC carriers, under which impairment-free reception should be achieved. The principal reference for such information is generated by a standards committee referred to as T3/A74. This defines the relative levels, commonly referred to as D/U (Desired to undesired) ratio, under which the receiver must function for undesired analogue and digital interferers at all channel offsets to the desired digital carrier

Currently receivers for ATSC principally employ single conversion architecture tuners to interface between the RF (radio frequency) and digital domains. A known example of such a single conversion tuner architecture is shown in FIG. 1 of the accompanying drawings.

In order to receive a typical broadcast spectrum from 50 to 860 MHz, the incoming spectrum is divided into three sub-bands as shown in FIG. 1, in which the sub-band frequencies shown are exemplary only. The sub-bands are processed by respective tuners A1, B1 and C1 of substantially identical construction and function. One such tuner is illustrated in FIG. 2 of the accompanying drawings.

The tuner has an RF input 1 connected to a first tuneable bandpass filter 2. The filter 2 is a single element filter, i.e. containing a single inductor/capacitor resonant network, whose centre frequency is arranged to track with the frequency of a desired received channel. In so doing, the filter 2 ‘selects’ the desired channel from the full received spectrum and provides a first attenuation to undesired channels. The filter 2 thus provides protection from intermodulation being generated in the immediately following stage and also provides a first attenuation to the image channel. The image channel lies at twice the output intermediate frequency (IF) above the desired channel in the case of a tuner using high-side mixing. The image channel is particularly problematic as it will lie directly on the desired channel after conversion unless it is significantly attenuated.

The output of the first tuneable filter 2 is coupled to an LNA/AGC (low noise amplifier/automatic gain control) stage 3. The stage 3 provides a first system variable gain with associated low NF (noise figure) and high signal handling capability. The output of the stage 3 is coupled to a second tuneable filter 4. The filter 4 is a dual element filter, i.e. containing two resonant networks normally arranged as a double-tuned loosely coupled structure whose centre frequency is again arranged to track with the desired channel frequency. The filter 4 provides further, higher Q attenuation to the undesired channels including the image channel. The filters 2 and 4 are often referred to as “image filters”. The level of attenuation provided by the first and second filters 2 and 4 is a key parameter of the tuner performance, since this defines the tuner selectivity and hence the performance in the presence of undesired channels.

The output of the second tuneable filter 4 is coupled to a mixer 5, which mixes the output signal from the filter 4 with a local oscillator signal provided by a local oscillator 9 controlled by a phase locked loop (PLL) synthesizer 10. The output of the mixer 5 is coupled to a roofing filter 6 and then to an output amplifier 7 which provides further gain and output impedance matching. The roofing filter is required to reduce the composite power presented to the amplifier 7 to prevent overload distortion effects in this stage. The desired channel is then supplied to the tuner output 8.

The roofing filter 6 serves to pass the desired channel and to reduce the energy supplied to the subsequent stages by attenuating all undesired channels. Such a filter generally has a bandpass characteristic with a bandwidth or “passband” substantially equal to the desired channel width and with an in-band ripple characteristic sufficiently low for the modulation characteristic of the desired channel. Outside the passband, the filter 6 has an attenuation which increases substantially monotonically with frequency difference from the passband centre frequency. In the known arrangement, the filter 6 is embodied as an active RC filter “on-chip”, i.e. in a monolithic integrated circuit forming part or all of the tuner.

The local oscillator (LO) 9 is controlled by the PLL synthesiser 10, which frequency-locks the local oscillator to a reference source (not shown). The synthesiser 10 sets the desired frequency by means of a control line 11 forming part of a feedback loop. The function of a PLL synthesiser is well known and documented and so will not be described further.

In a typical implementation of this known architecture, the mixer 5, the IF amplifier 7 and the local oscillator 9 of each of the tuners A1, B1 and C1 together with a common PLL synthesiser 10 are disposed in a common integrated circuit. The filters 2, 4 and the stage 3 are formed separately for each of the tuners A1, B1 and C1.

The tracking filters 2, 4 and the local oscillator 9 all employ similar resonant networks formed from varactor diodes and air coils such that their resonant frequencies substantially track over the required operating frequency range with a frequency offset between the local oscillator network and filter networks equivalent to the output intermediate frequency. “Air coils” are inductive elements formed from a number of wound coils of wire. In production, the tracking alignment between the filters 2, 4 and the local oscillator (9) is adjusted for the best performance compromise across the required operating frequency range by manually adjusting the air coils. This typically involves moving the coils closer together or further apart, thus adjusting their inductance and hence adjusting the characteristic response at a number of frequency points.

By means of these techniques, it is possible to provide RF filtering ahead of the mixer 5 capable of achieving a tracking bandwidth of between 3 and 6 channels and an image cancellation of typically 55 dB. The image response is particularly important for ATSC, since the required performance is to achieve satisfactory operation in the presence of an image channel that is 50 dB higher in amplitude than the desired channel.

The image channel in ATSC transmissions may be a further ATSC channel, which by the nature of its coding appears as a noise-like signal. The image channel therefore has the same effect as a noise source on the desired channel and so degrades the C/N (Carrier to Noise) ratio of the desired channel. It is well documented that typical ATSC demodulators require a C/N ratio of approximately 15 dB to deliver QEF (Quasi Error Free) reception. The image channel must therefore be attenuated by a minimum of 50+15 dB, thus demanding image cancellation of at least 65 dB to meet published standards requirements.

This highlights a difficulty with the above-described architecture since it is extremely challenging to deliver greater than 55 dB of image cancellation across the whole operating frequency range. This is because the tracking filters 2,4 are fundamentally limited by their Q factor and the compromise associated with tuning across a wide frequency range. It is also difficult to achieve adequate physical isolation across each filter, which results in direct leakage across each filter. There is a further difficulty associated with the filter bandwidth because adjacent channels are also passed and these can have levels in excess of 40 dB higher than that of the desired channel. This may cause overload, principally in the mixer 5 because there is usually high gain associated with the stage 3.

### SUMMARY

According to a first aspect of the invention, there is provided a single conversion tuner comprising an image reject downconverter including first and second mixers, at least one tracking radio frequency filter disposed ahead of the downconverter for providing image attenuation, and first and second inductance-capacitance roofing filters for filtering the output signals of the first and second mixers, respectively.

The roofing filters may be alignable.

The downconverter may be formed in a single chip and the roofing filters may be formed off the chip.

The roofing filters may be arranged to provide a relative phase shift of 90°.

According to a second aspect of the invention, there is provided a single conversion tuner comprising an image reject downconverter and at least one tracking radio frequency filter disposed ahead of the downconverter for providing image rejection, the downconverter comprising first and second mixers, first and second roofing filters for filtering output signals of the first and second mixers, respectively, and a combiner for forming a linear combination of output signals of the first and second roofing filters.

The first and second roofing filters may be inductance/capacitance filters.

The first and second filters may be passive filters.

The downconverter may comprise a quadrature commutating signal generator arranged to supply quadrature commutating signals to the first and second mixers.

The roofing filters may be arranged to provide a relative phase shift of 90° between the output signals thereof. The combiner may comprise a summer.

The combiner may be arranged to provide a relative phase shift of 90° between the input signals thereof.

The roofing filters may be alignable.

The first and second mixers and the combiner may be formed in a single chip and the first and second filters may be formed off the chip.

The at least one tracking filter may comprise three tracking inductance/capacitance filter sections.

The or each tracking filter may comprise a bandpass filter.

It is thus possible to provide an architecture whereby at least some of the difficulties of existing architectures can be reduced or overcome, so delivering a single conversion architecture capable of operating over the full required operating envelope.

### BRIEF DESCRIPTION OF THE DRAWINGS

FIG. 1 is a block schematic diagram of a known type of tuner architecture;

FIG. 2 is a block circuit diagram of a known tuner;

FIG. 3 is a block circuit diagram of a tuner constituting an embodiment of the invention; and

FIG. 4 is a diagram illustrating operation of an image reject mixer.

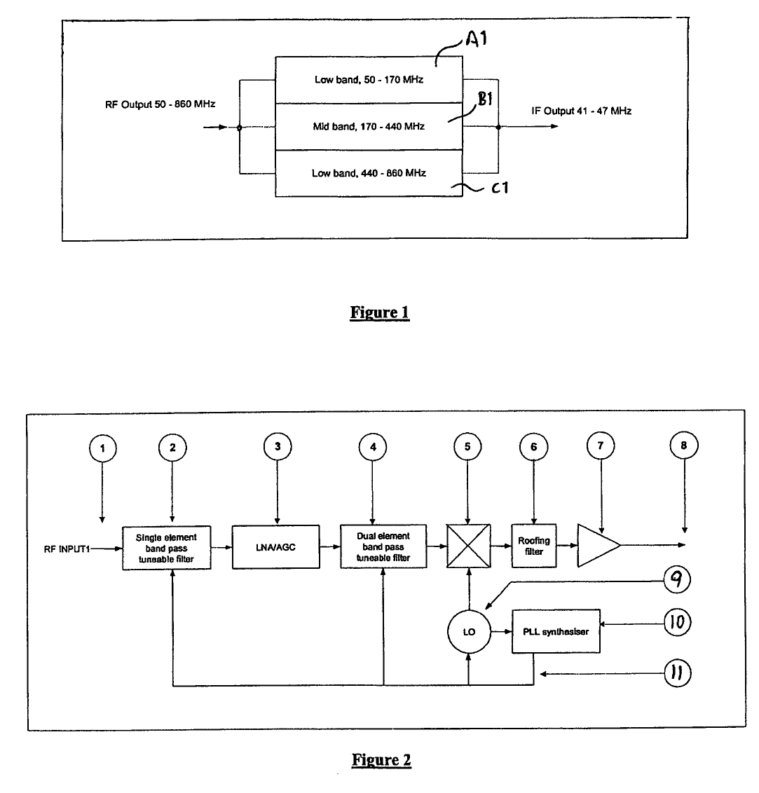

Like reference numerals refer to like parts throughout the drawings.

### DETAILED DESCRIPTION

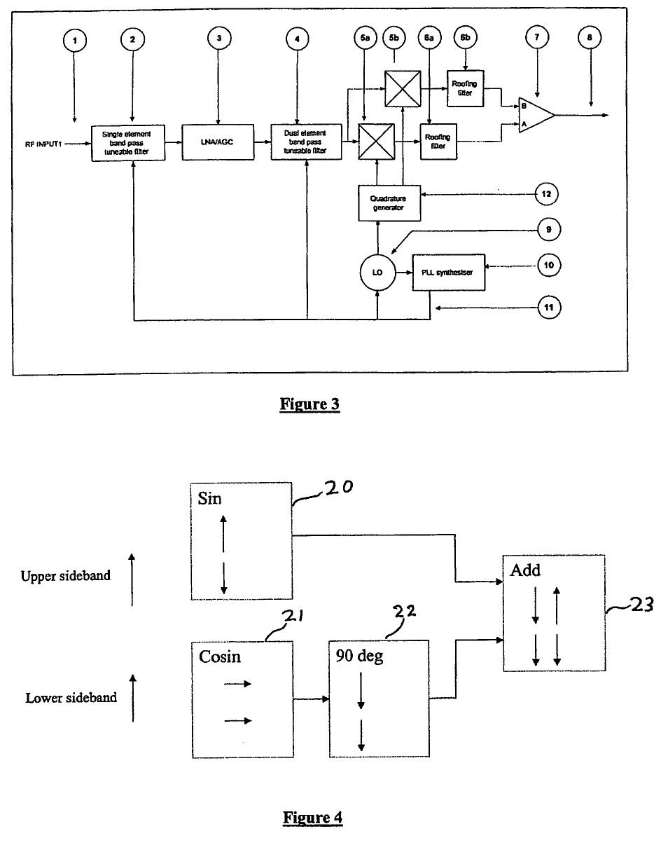

The stages 1 to 4, 7, 9 and 10 of the tuner shown in FIG. 3 perform the same functions as the corresponding stages of the tuner shown in FIG. 2 and will not, therefore, be described again in detail. Thus, for example, the filters 2 and 4 provide similar levels of attenuation to undesired channels including the image channel.

The output of the second tracking filter 4 of the tuner shown in FIG. 3 is connected to two mixers 5a and 5b operating “in parallel”. Commutating signals for the mixers 5a and 5b are arranged to have a 90 degree phase shift therebetween and are provided by a quadrature phase shift generator 12 supplied by the local oscillator 9 under control of the PLL synthesiser 10. However, other arrangements are well known and documented for generating quadrature signals from a local oscillator, which may also involve the combination of a local oscillator with a quadrature phase shift network. Any suitable arrangement may be used.

The mixers 5a, 5b produce intermediate frequency outputs which share the same quadrature phase shift relationship as the commutating signals. The outputs of the mixers 5a and 5b are then coupled directly into respective interstage roofing filters 6a and 6b. The filters 6a and 6b reduce the composite power presented to the following stage and in addition are arranged to provide a further 90 degree phase shift between the signals which they pass. To achieve the required accuracy, the filters 6a and 6b may require alignment for both the centre passband matching and phase shift generation accuracy.

The outputs of the filters 6a and 6b are coupled to summing inputs A and B of the output amplifier 7, whose output is connected to the tuner output 8. The signals at the inputs A and B are internally summed to provide attenuation of the image channel.

As described hereinbefore, the tuner of FIG. 3 requires production alignment such that the tracking filters 2, 4 and the local oscillator 9 maintain appropriate frequency relationships across the operating frequency range when controlled by a common control line 11. In addition, the roofing filters 6a and 6b may also require alignment during or subsequent to manufacture.

The filters 6a and 6b are formed off-chip as LC (inductance/capacitance) filters and provide the required roofing characteristics as described hereinbefore but of improved performance. Providing these filters off-chip and using LC filters reduces the power dissipation in the chip and in the tuner by: replacing active filtering with passive filtering; avoiding dissipation of power in resistive components of RC filtering; and providing improved quality of filtering so that subsequent stages receive less undesired channel energy and can be run with lower power dissipation while achieving acceptable intermodulation performance.

It is thus possible to provide further image cancellation in the stages following the tracking filtering and in so doing to provide the required level of image suppression to achieve specified image channel D/U ratio performance. This technique has advantages in that it enables an image reject capability to implemented which requires little additional power and circuitry. This is achieved, at least in part, through applying roofing filtering coupled directly to the mixers 5a and 5b and ahead of any further active circuitry. By so doing, the signal handling requirements of following stages is greatly reduced so that the required power dissipation becomes compatible with integrated circuit techniques and tuner manufacturer expectations.

Power is an issue without the present technique since:
1) mixing will produce upper and lower sidebands which will double the signal handling requirements of stages “post-mixing”, assuming no filtering is applied;
2) the mixer will also output adjacent channels above and below the desired channel which will have a high D/U ratio compared to the desired channel and will therefore require greater signal handling and power dissipation so as to limit generation of intermodulation products.

The present technique overcomes this because, by applying the roofing filters 6a, 6b after the mixers 5a, 5b, the upper sideband and adjacent channel powers are substantially reduced

In an alternative embodiment, the filters 6a and 6b may be arranged only to provide a roofing characteristic and the output amplifier 7 is arranged to provide a 90 degree phase shift between the signals at its input A and B.

The mixers 5a and 5b, together with the quadrature commutating signals, the 90 degree relative phase shift through the filtering paths and the summation by the amplifier 7, form an image reject mixer whose operation is illustrated in FIG. 4. The principle of such an image reject mixer is to mix the input signal with Sine and Cosine commutating signals such that, after conversion, one sideband will have a positive sine and the other a negative sine (as shown at 20) whereas both will have same sense cosine (as shown at 21). The sine or cosine signals are then phase-shifted by a further 90 degrees (as shown at 22) and, due to the 180 degree phase shift introduced between the two sidebands, one will be in phase with the cosine and the other in antiphase (as illustrated at 23), thus cancelling one sideband whilst constructively adding the other. By this process, one sideband is downconverted and the other is cancelled.

1. A single conversion tuner comprising an image reject downconverter including first and second mixers providing output signals, at least one tracking radio frequency filter disposed ahead of said downconverter for providing image attenuation, and first and second inductance-capacitance roofing filters for filtering said output signals of said first and second mixers, respectively.

2. A tuner as claimed in claim 1, in which said roofing filters are alignable.

3. A tuner as claimed in claim 1, comprising a chip in which said downconverter is formed, said roofing filters being formed off said chip.

4. A tuner as claimed in claim 1, in which said roofing filters are arranged to provide a relative phase shift of 90 degrees.

5. A tuner as claimed in claim 1, comprising a combiner for forming a linear combination of output signals of the first and second roofing filters.

6. (canceled)

7. A tuner as claimed in claim 5, in which said the first and second filters are passive filters.

8. A tuner as claimed in claim 5, in which said downconverter comprises a quadrature commutating signal generator arranged to supply quadrature commutating signals to said first and second mixers.

9. A tuner as claimed in claim 5, in which said roofing filters are arranged to provide a relative phase shift of 90 degrees between said filtered signals.

10. A tuner as claimed in claim 9, in which said combiner comprises a summer.

11. A tuner as claimed in claim 5, in which said combiner is arranged to provide a relative phase shift of 90 degrees between input signals thereof.

12. A tuner as claimed in claim 5, in which said roofing filters are alignable.

13. A tuner as claimed in claim 5, comprising a chip in which said first and second mixers and said combiner are formed, said first and second filters being formed off said chip.

14. A tuner as claimed in claim 5, in which said at least one tracking filter comprises three tracking inductance/capacitance filtering sections.

15. A tuner as claimed in claim 5, in which said at least one tracking filter comprises a bandpass filter.
